(19) United States
(12) Patent Application Publication
(10) Pub. No.: US 2004/0170447 A1
(43) Pub. Date: Sep. 2, 2004

(54) Image forming apparatus using installable process cartridge, method of positioning process cartridge, and process cartridge itself

(76) Inventors: Yuji Arai, Kawasaki (JP); Atsushi Sampe, Yokohama (JP); Kiyonori Tsuda, Yokohama (JP); Takeo Suda, Tokyo (JP); Satoshi Hatori, Yokohama (JP); Tomoji Ishikawa, Yokohama (JP); Naoto Watanabe, Yokohama (JP); Hiroyuki Nagashima, Yokohama (JP); Yoshiyuki Kimura, Tokyo (JP); Nobuo Kuwabara, Yokohama (JP); Hiroshi Hosokawa, Yokohama (JP); Hideki Zemba, Yokohama (JP); Wakako Murakami, Tokyo (JP); Satoshi Narumi, Yokohama (JP); Ryuta Takeichi, Yokohama (JP); Masanori Kawasumi, Yokohama (JP); Kazuhiko Umemura, Yokohama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/788,488

(22) Filed: Mar. 1, 2004

(30) Foreign Application Priority Data
Feb. 28, 2003 (JP) 2003-054072

(51) Int. Cl. G03G 21/16

(52) U.S. Cl. 399/111

(57) ABSTRACT

A method and apparatus of image forming include a process cartridge detachably mounted therein. The process cartridge includes a photoconductive element and a housing storing the photoconductive element and including a guide portion guiding the process cartridge. The guide portion faces an inner wall of the image forming apparatus or another process cartridge adjoining thereto and guides the adjoining process cartridge. The guide portion slidably engages with a portion of the process adjoining cartridge . The guide portion varies in shape according to its position in the image forming apparatus. The guide portion may be separately formed from or integrated with the housing. A method and apparatus of an image forming includes an image transfer mechanism and a plurality of process cartridges arranged in parallel. Each of the process cartridges includes photoconductive elements and a housing, and forms an image for a single separated color.

### BACKGROUND OF THE INVENTION

This patent specification is based on Japanese patent application, No.JPAP2003-054072 filed on Feb. 28, 2003 in the Japanese Patent Office, the entire contents of which are incorporated by reference herein.

### FIELD OF THE INVENTION

The present invention relates to a method and apparatus for image forming, and more particularly to a mechanism in the method and apparatus for positioning a process cartridge which houses a combination of image forming devices.

### DISCUSSION OF THE BACKGROUND

An image forming apparatus, such as a copier, a printer, or a facsimile, visualizes an electrostatic latent image formed on a latent image carrier, i.e., a photoconductor, with a developer, and transfers the image visualized onto a sheet or the like, thereby obtaining a recorded output.

As a configuration for an image forming apparatus, the image forming apparatus may adopt, besides a configuration using single photoconductor for one color, a configuration including a plurality of photoconductors to form a plurality of corresponding colored images. The image forming apparatus with a plurality of photoconductors is used for forming a multi-colored image such as a full-colored image.

In order to obtain a full-colored image, for example, one applicable method is sequentially superimposing each of the colored images formed on the photoconductors with developer having a complementary color of a separated color onto a sheet being conveyed. Another method is transferring a plurality of images from each of the photoconductors one by one onto a common position of an intermediate transferor and then transferring an image superimposed thereon onto a sheet at one time.

As a configuration of using a plurality of photoconductors, what is called tandem architecture is generally known. In the tandem architecture, photoconductors for each color are parallely arranged in an extending direction of a belt which works as an intermediate transferor receiving images superimposed from photoconductors thereon, as described in Japanese Patent Laid-Open Application Publication No. 10-39718, for instance.

Japanese Patent Laid-Open Application Publication No. 10-39718 proposes, for instance, a configuration capable of forming a multi-colored image like the tandem architecture in which a cartridge for image forming is installed into an image forming apparatus. The process cartridge accommodates a combination of a photoconductor and image forming devices carrying out an image forming process thereon.

Each image forming device installed in the process cartridge needs to have specified alignment in order to prevent generated image from being defective. In order to meet this requirement, a configuration has been provided capable of independently positioning a developing device and a cleaning device used in the process cartridge in relation to the photoconductor.

In an image forming apparatus of forming a multicolored image with a plurality of process cartridges, a photoconductor in a process cartridge needs to have a specified position in relation to other photoconductor, that is, it needs to maintain registration, when the process cartridge is installed. This configuration is necessary in order to prevent color displacement caused by transfer displacement among one-color images.

In order to install the process cartridges into the image forming apparatus, a member installed in the apparatus has been used such as a guiding rail or a drawer capable of sliding and holding the cartridges. However, the growing demand for smaller image forming apparatus in recent years requires more compact configuration, demanding optimized space utilization between the process cartridges, which space has been occupied traditionally with guiding rails or drawers.

In addition, conventional apparatuses have configuration that requires the specification of a relative position of each image forming device to the photoconductor installed in the process cartridge. Likewise, each process cartridge positioning of itself in relation to other process cartridges.

### SUMMARY OF THE INVENTION

In view of the foregoing, it is an object of the present invention to provide a novel process cartridge used in an image forming apparatus which includes a guiding portion for guiding the process cartridge.

Another object of the present invention is to provide a novel method of providing a process cartridge in an image forming apparatus which includes a guiding portion for guiding the process cartridge.

To achieve these and other objects, in one example, the present invention provides a novel process cartridge including a photoconductive element and a housing. The housing houses the photoconductive element and includes a guide portion guiding the process cartridge.

The guide portion of the process cartridge may face an inner wall of the image forming apparatus or another process cartridge adjoining it.

The guide portion may also guide another adjoining process cartridge.

The guide portion may slidably engage with a portion of an adjoining process cartridge .

The guide portion may vary in shape in accordance with a location in the image forming apparatus.

The guide portion may be separately formed from the housing or be integrated there with.

The present invention also provides a novel image forming apparatus including an image transfer mechanism and a process cartridge detachably mounted. The process cartridge includes a photoconductive element and a housing. The housing houses the photoconductive element and includes a guide portion guiding the process cartridge.

The present invention also provides a novel image forming apparatus including an image transfer mechanism and a plurality of process cartridges detachably mounted and arranged in line in parallel. Each one of the plurality of process cartridges forms an image for a single separated color, and includes a photoconductive element and a housing. The housing houses the photoconductive element and includes a guide portion guiding the process cartridge.

This patent specification further describes a novel method of providing a process cartridge detachably mounted in an image forming apparatus.

In one example, the novel method includes the steps of providing a photoconductive element and storing the photoconductive element. The providing step provides the photoconductive element. The storing step stores the photoconductive element in a housing including a guide portion guiding the process cartridge.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram showing an exemplary configuration of an image forming apparatus adopting process cartridges according to an embodiment of the present invention;

FIG. 2 is a schematic diagram showing an enlarged view of one of the process cartridges equipped in the image forming apparatus in FIG. 1;

FIG. 3 is a schematic diagram illustrating a guiding mechanism structure with a plurality of process cartridges similar to the one shown in FIG. 2;

FIG. 4 is a schematic diagram showing an enlarged view of a part of the structure shown in FIG. 3;

FIG. 5 is a schematic diagram showing another exemplary structure of guiding members in process cartridges installed in the image forming apparatus shown in FIG. 1;

FIG. 6 illustrates a vertical sectional view of a fullcolor image forming apparatus according to another embodiment of the present invention;

FIG. 7 illustrates an enlarged sectional view of an image carrying member and an image forming mechanism arranged around the image carrying member;

FIG. 8 illustrates a sectional view of a guide having guide portions arranged in a stepped manner;

FIG. 9 illustrates a process cartridge provided with a guide groove and a guide protrusion;

FIG. 10 illustrates a perspective view of the image forming apparatus of FIG. 11 with a front-side cover plate opened;

FIG. 11 illustrates a vertical sectional view of an image forming apparatus according to another embodiment of the present invention;

FIG. 12 illustrates a partial perspective view of the image forming apparatus of FIG. 16, showing an inside of the image forming apparatus with the process cartridges removed;

FIG. 13 illustrates an enlarged view of a guide portion of the image forming apparatus of FIG. 16;

FIG. 14 illustrates a partial perspective view of a process cartridge with a lever positioned to release the process cartridge from the guide portion;

FIG. 15 illustrates a side view of the process cartridge with the lever positioned to lock the guide portion;

FIG. 16 illustrates a rear-side perspective view of the process cartridge; and

FIG. 17 illustrates an enlarged, rear-side, partial view of the process cartridge .

### DETAILED DESCRIPTION OF THE PREFERRED EMBODIMENTS

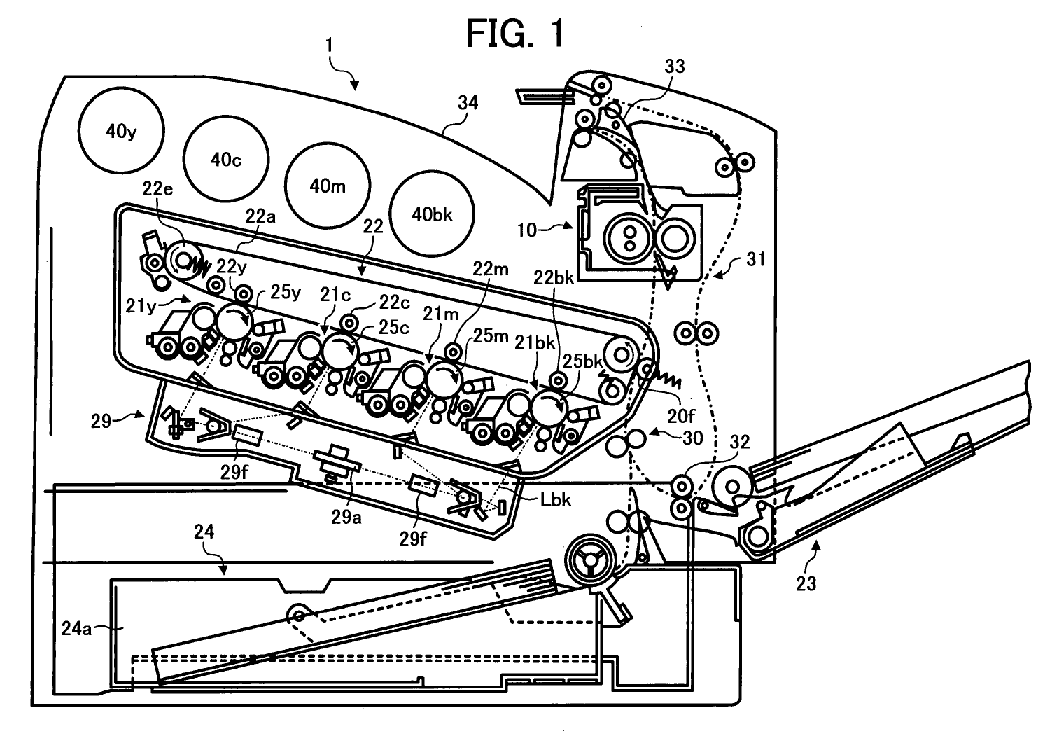

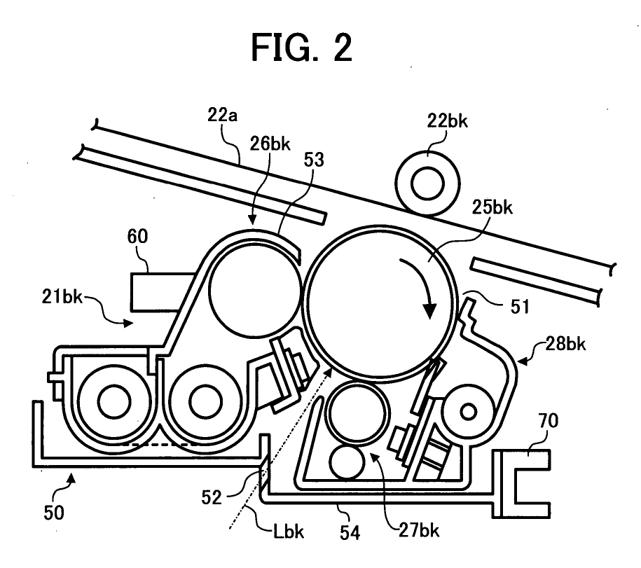

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIGS. 1 and 2, an image forming apparatus 1 according to an exemplary embodiment of the present invention is described. In FIG. 1, the image forming apparatus 1 includes a fusing device 10, a transfer device 20, a transfer belt 20a, a driving roller 20e, a secondary bias transferor 20f, image forming mechanisms 21y, 21c, 21m, and 21bk, and bias transferors 22y, 22c, 22m, and 22bk. The image forming apparatus 1 shown in FIG. 1 further includes a manual feeding tray 23, a paper feeding device 24, a paper feeding cassette 24a, photoconductive drums 25y, 25c, 25m, and 25bk, a writing device 29, a polygon motor 29a, and f lenses 29f. The image forming apparatus 1 shown in FIG. 1 also includes registration rollers 30, a reverse circulating path 30, feeding rollers 31, a conveying-path switcher 32, a paper output tray 34, and toner supply tanks 40y, 40c, 40m, and 40bk.

As shown in FIG. 2, the image forming apparatus 1 further includes a developing device 26bk, a cleaning device 27bk, and a charging device 28bk in the image forming mechanism 21bk. The image forming apparatus 1 in FIG. 2 also includes a process cartridge 50, an opening 51, an introducing mouth 52, a top wall 53, a bottom wall 54, guiding members 60 and 70 attached to the process cartridges 50, and guiding members 80 and 90.

FIGS. 1 and 2 also show a writing laser beam Lbk and arrows indicating rotating directions of the photoconductive drums 25.

The image forming mechanisms 21y, 21c, 21m, and 21bk form images of yellow, cyan, magenta, and black color, respectively, according to an original image. The transferors 22y through 22bk faces the image forming mechanisms 21y through 21bk, respectively. The manual feeding tray 23 and the paper feeding cassette 24a feed a recording sheet into a transfer area in which the image forming mechanisms 21y through 21bk and the transferors 22y through 22bk are opposed each other, respectively. The paper feeding cassette 24a is placed in the paper feeding unit 24. The registration rollers 30 feed the recording paper sent from the manual feeding tray 23 or the paper feeding cassette 24a in synchrony with operations of the image forming mechanisms 21y through 21bk. The fusing device 10 carries out a fusing operation on the recording sheet having an image transferred from the transfer device 20.

The fusing device 10, adopting a heat roller fusing method, fixes the image onto the recording sheet through a process of melting, softening, and penetrating by using a heating roller and a platen roller. The heating roller and the platen roller may be placed side by side of a conveying path of the recording sheet.

The transfer device 20 includes the transfer belt 20a wound on a plurality of rollers, working as a transfer member. The transfer device 20 also includes the bias transferors 22y, 22c, 22m, and 22bk facing corresponding drums 25y, 25c, 25m, and 25bk in the image forming mechanisms 21y, 21c, 21m, and 21bk, respectively. The bias transferors 22y, 22c, 22m, and 22bk apply transfer bias having reversed polarity of toner to sequentially superimpose toner images formed with the image forming mechanisms onto the transfer belt 20a.

The image transfer device 20 further includes a secondary bias transferor 20f located on a conveying path of the recording sheet,transfering toner images superimposed on the transfer belt 20a onto the recording sheet .

In the image forming apparatus 1 shown in FIG. 1, the transfer device 20 is disposed inside of the image forming device 1 on a slope, thereby occupying less space horizontally.

The image forming apparatus 1 in FIG. 1 is an example of a color printer adopting a tandem method capable of forming a full-colored image. At the same time, the present invention is equally applicable to other image forming apparatus, such as, for example, a copier, a facsimile, a duplicator, or the like as an image forming apparatus as well.

In addition to normal paper generally used for copying, the image forming apparatus 1 is able to process specific paper having higher heat capacity such as 90K paper including OHP sheet, cards, or postcards, cardboard having a specific weight of 100 g/m2 or more, or envelopes.

The image forming mechanisms 21y, 21c, 21m, and 21bk in FIG. 1 carry out development of yellow, cyan, magenta, and black images, respectively. As all image forming mechanisms have identical arrangements except a color of toner, only the image forming mechanism 21bk will be described as a representative example.

The photoconductive drum 25bk in the image forming mechanism 21bk works as an electrostatic latent image carrier. Along with the rotating direction indicated with arrows in FIGS. 1 and 2 of the photoconductive drum 25bk, the charging device 27bk, the developing device 26bk, and the cleaning device 28bk are sequentially arranged. At a location between the charging device 27bk and the developing device 26bk on the photoconductive drum 25bk, a latent image according to an image information corresponding to a separate color is formed with the writing laser beam Lbk emitted from the writing device 29. As an electrostatic latent image carrier, a beltlike shaped member may be adopted instead of a drum-shaped member. These devices for image forming arranged around the photoconductive drum 25bk are combined into the process cartridge 50 which is configured to have a unit structure and a housing, as shown in FIG. 2.

In the image forming apparatus 1 of the above configuration, an image is formed according to the following processes and conditions. The following example describes the image forming mechanism 21bk using black toner as a representative image forming mechanism. It is to be noted, however, that the image forming mechanisms of other colors are configured in a similar manner.

In an image forming process, the photoconductive drum 25bk is driven to rotate by a main motor (not shown), and first discharged with alternating current (AC) bias having no direct current (DC) component applied to the charging device 27bk. The photoconductive drum 25bk thus have its surface potential set to standard potential of approximately −50V.

Subsequently, the charging device 27bk applies a DC bias superimposed to AC bias the photoconductive drum 25bk. The photoconductive drum 25bk is evenly charged to have a surface potential equivalent to the DC component charged, i.e., approximately −500V to approximately −700V. A preferable value of the surface potential is determined by a process controlling unit.

Upon completion of the uniform charging of the photoconductive drum 25bk, a writing process starts. An image is written with the writing device 29 according to digital image information from a controller (not shown) in order to form a latent image. That is, in the writing device 29, a laser light source emits a laser beam based on a digitized signal for each color according to the digital image information. The laser beam passes through cylinder lens (not shown), the polygon motor 29a, the f6 lenses 29f, first, second, and third mirrors, and the WTL lens (not shown). The photoconductive drum carrying an image of each color, in this case the photoconductive drum 25bk, is irradiated with the laser beam. Each area on the surface of the photoconductive drum 25bk irradiated to have a surface potential of approximately −50V, thereby forming a latent image according to the image information.

The latent image formed on the photoconductive drum 25bk is visualized by the toner applied thereto by the developing device 26bk using complemental color toner of a separated color. A developing process then applies a voltage signal to a developing sleeve of approximately −300V to approximately −500V DC with an AC bias in order to develop the toner (Q/M: −20 to −30 μC/g) on image areas having lower potential caused by the irradiation of the laser beam, thereby forming the toner image.

A toner image of each color visualized in the developing process is transferred onto the recording sheet being fed with a predetermined timing from the registration rollers 30. The recording sheet is applied attaching bias from rollers before reaching the transfer belt 22a. The recording sheet thus attaches to the transfer belt 22a due to electrostatic.

Each of the bias transferors 22y, 22c, 22m, and 22bk installed in the transfer device 20 and facing the respective photoconductive drum applies a bias having reversed polarity of toner onto the transfer belt 20a. This action causes the photoconductive drums to electrostatically transfer toner images onto the transfer belt 20a. The toner images superimposed on the transfer belt 20a are finally transferred to the recording sheet by the secondary bias transferor 20f.

The recording sheet with each color image transferred is self stripped from the transfer belt 22a with the driving roller 22b of a transfer belt unit, and conveyed to the fusing device 10. The toner image is fixed onto the recording sheet as it passes through a fusing nip including a fusing belt and pressing rollers. The recording sheet then is ejected onto the paper output tray 34.

The image forming apparatus 1 shown in FIG. 1 is capable of forming a double-sided image on the recording sheet ejected from the fusing process, as well as a single-sided image . When forming a double-sided image, the recording sheet exiting the fusing process is conveyed to a reversal circulating path 31 by use of registration rollers 30 and feeding rollers 32 . The feeding rollers 32 are also used to feed a sheet placed on the manual feeding tray 23. The conveying path of the recording sheet is switched by a conveying path switcher 33 installed at a rearward location of the fusing device 10, depending whether a single-sided or double-sided image is being formed.

It is to be understood that each of the above-described features, such as, for example, charging potentials is not limited to values and attributes stated in the above description, but may vary naturally based on other operating parameters, such as, for example, color and/or density.

FIG. 2 illustrates an exemplary configuration of the process cartridge 50 formed with a housing molded from resinous material. The image forming mechanism 21bk for a black colored image is provided, on its housing, with the opening 51 on a side facing the transfer belt 20a for exposing a part of the photoconductive drum 25bk, and the writing light introducing mouth 52 on the other side facing the writing device 29.

The process cartridge 50 is attached or detached along a line substantially in a longitudinal direction, or an axis of the photoconductive drum 25bk. In the present embodiment, the attaching/detaching line is perpendicular to a sheet surface of the FIG. 2 from which the process cartridge 50 can be withdrawn for maintenance or inspection.

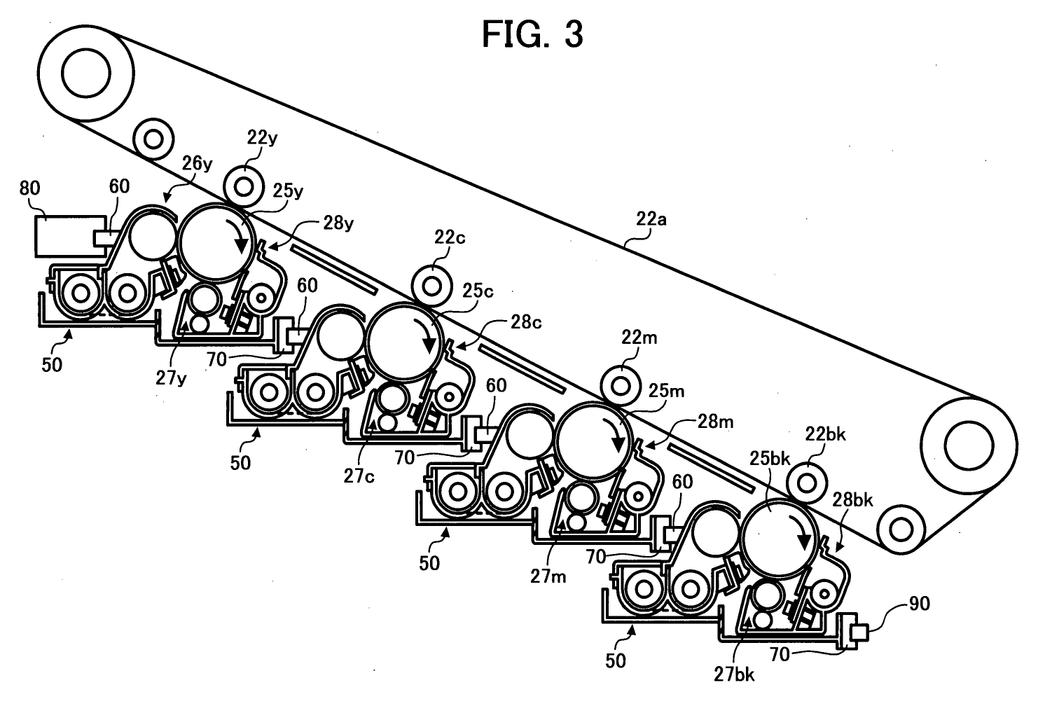

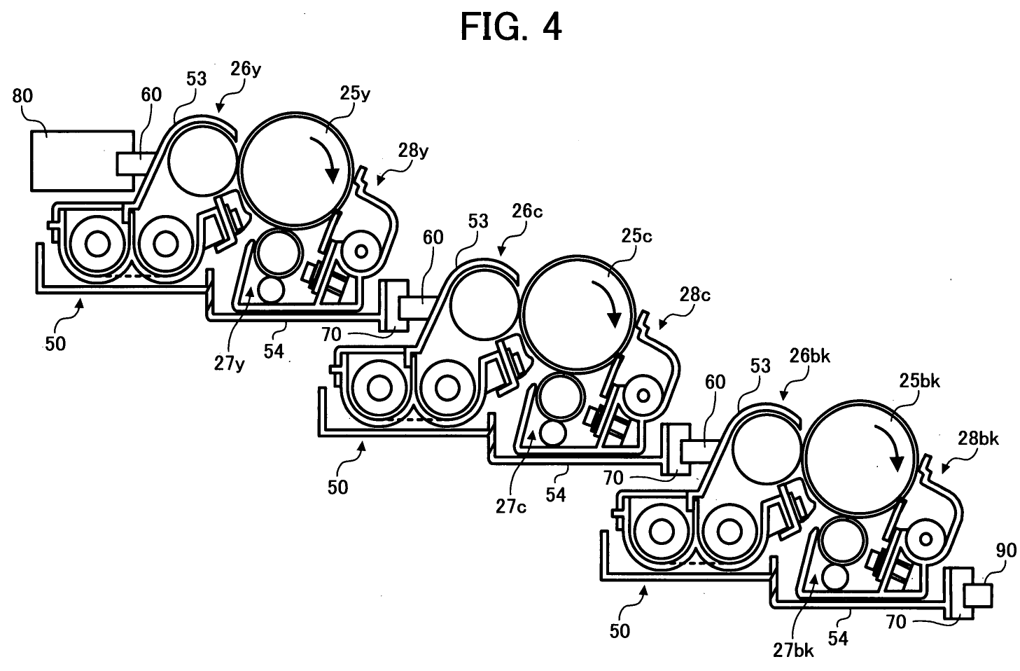

Referring to FIGS. 3 and 4, further details of the image forming apparatus 1 will now be described. In FIG. 3 and FIG. 4, on an outer wall of the process cartridge 50, the top wall 53 of the developing device 26bk facing adjoining process cartridge is provided with the guiding member 60 while the bottom wall 54 of the cleaning device 28bk is provided with guiding member 70. The process cartridge 50 for magenta color is omitted in FIG. 4.

As shown in FIG. 3, the guiding member 80 is placed inside the housing contacting the guiding member 60 attached to the process cartridge 50 on the left side to guide the process cartridge 50 being attached or detached. Similarly, the guiding member 90 is placed inside the housing contacting the guiding member 70 attached to the process cartridge 50 on the right side to guide the process cartridge 50 being attached or detached.

Each of the guiding members 60 and 70 is arranged to face the adjoining process cartridge. The guiding member 60 is formed to protrude as a male member, while the guiding member 70 is formed to recess as a female member engaging the guiding member 60. Each of the guiding members 60 and 70 is provided with enough length to hold travel of attachment/detachment of the process cartridge 50 along a line perpendicular to the page in FIGS. 3 and 4.

Since the guiding members 60 and 70 are configured to protrude and recess, respectively, they are able to fit each other, as shown in FIG. 4. When the guiding members 60 and 70 fit each other, a tip of the guiding member 60 is inserted and engaged to the guiding member 70. In this configuration, space between the process cartridges is reduced in comparison to a mounting process using guiding members without engagement.

Each of the guiding members 60 and 70 in a state of engagement pushes against a wall of the adjoining process cartridge 50. This configuration assures that the needed amount of space between process cartridges 50 is maintained, thereby enabling the positioning of adjacent process cartridges 50 to each other.

The guiding members 60 and 70 may be formed separately from the housing of the process cartridge 50 and attached thereto afterward, or formed together with the housing of the process cartridge 50.

In the former case, the guiding members 60 and 70 may be joined or fastened to the housing of the process cartridge 50.

According to the above configuration, the process cartridge 50 moving inward in the image forming apparatus 1 is able to use the guiding members 60 and 70 of the adjoining process cartridges 50. Moreover, when loaded in the image forming apparatus 1, each process cartridge 50 is able to keep its position therein because the guiding members 60 and 70 determine the amount of space between the process cartridges 50. The guiding members 60 and 70 enable movement of the process cartridges 50 by beading its weight. Each of the guiding members 60 and 70 is separately placed from the other, side by side of a vertical centerline of the process cartridge 50. According to this configuration, the process cartridge 50 just receives gravity at horizontal relative positions, and is capable of sliding without receiving any couple of force. As a matter of course, each of the guiding members 60 and 70 of the process cartridge 50 has an appropriately sized tip at a horizontal end to fit an opponent so that the process cartridge 50 slides smoothly without receiving any additional external horizontal force. The above configuration eliminates the necessity of the image forming apparatus 1 to have a member for guiding the process cartridge 50 in motion or positioning the process cartridge 50, thereby reducing the space occupied by the process cartridges 50, and the overall size of the image forming apparatus 1.

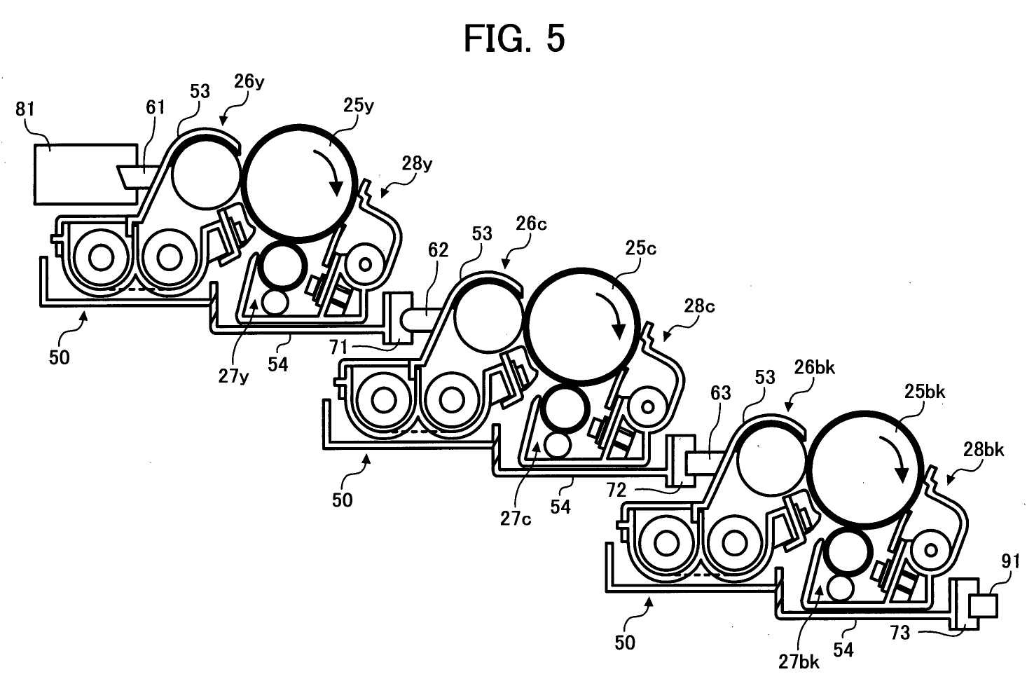

Referring now to FIG. 5, another embodiment of the image forming apparatus 1 according to the present invention will now be described. FIG. 5 includes guiding members 61, 62, 63, 71, 72, and 73 instead of the guiding members 60 and 70 in FIGS. 2 through 4. Guiding members 81 and 91 of the image forming apparatus are also shown in FIG. 5 as substitutes of guiding members 80 and 90. Other reference numbers in FIG. 5 are identical with the reference numbers in the first embodiment. The tip shape of each of the guiding members 61, 62, and 63, respectively, varies for each process cartridge 50 in order to fit the corresponding other guiding member 71, 72, and 73 .

In the exemplary embodiment shown in FIG. 5, the process cartridge 50 in the left includes the guiding member 61 having a protruding slanting tip which fits the guiding member 81, and the guiding member 71, having a recessing arcing tip. The process cartridge 50 in the middle includes the guiding member 62, having a protruding arcing tip which fits the recessing arcing tip of the guiding member 71, and the guiding member 72, having a recessing rectangular tip. The process cartridge 50 in the right includes the guiding member 63, having a protruding rectangular tip which fits the recessing rectangular tip of the guiding member 72, and the guiding member 73, having a recessing rectangular tip which fits the guiding member 91.

The above configuration prevents misplacing of the process cartridge 50 in the image forming apparatus 20 housing a plurality of process cartridges to form separate color images. Into a position at which each of the guiding members 61, 62, and 63 and 71, 72, and 73 matches its opponent, the process cartridge 50 can be loaded. This consequently determines a loading position of the process cartridge 50 taking into consideration the correct order. The guiding members 61, 62, and 63 and 71, 72, and 73 thus allow the loading position to be identified based on the shapes process of the different guiding members of each cartridge 50 to be installed in the image forming apparatus 1.

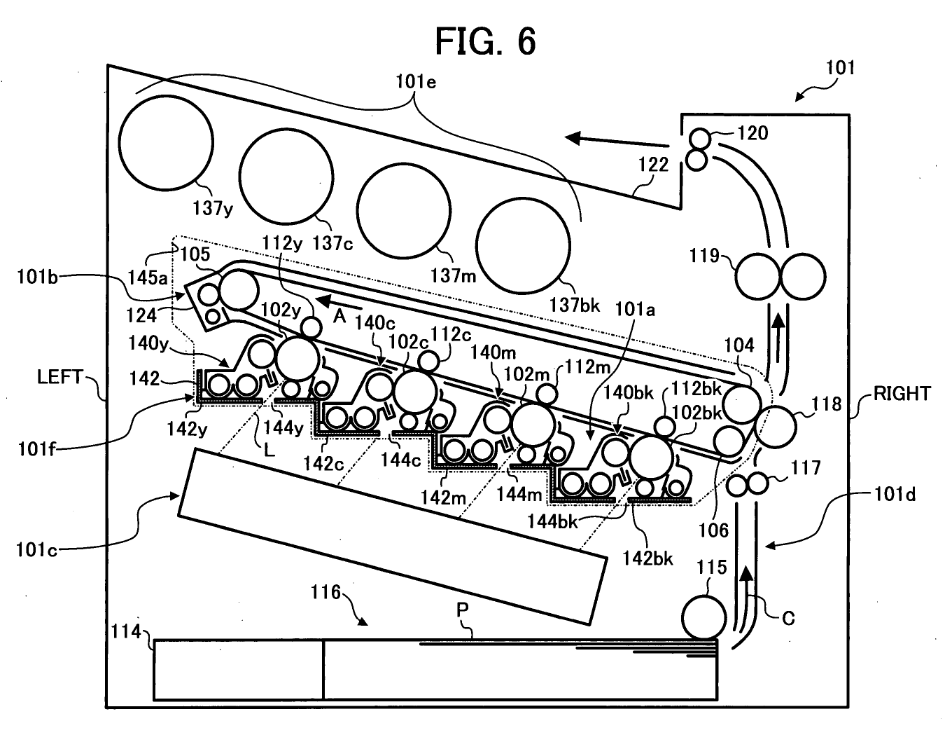

Referring to FIG. 6, another embodiment of the present invention will now be described. In FIG. 6, an image forming apparatus 100 is shown that includes an image forming mechanism 101a, a transfer medium 101b, an optical writing system 101c, a sheet feeding mechanism 101d, a toner feeding mechanism 101e, and a guiding mechanism 101f.

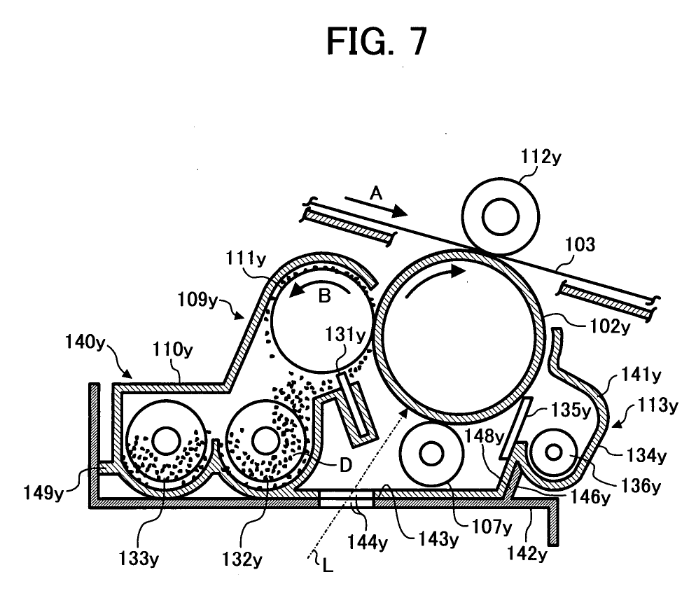

The image forming mechanism 101a generally includes four process cartridges 140y, 140c, 140m, and 140bk which are explained with reference to FIG. 7. FIG. 7 illustrates an enlarged sectional view of that process cartridge, focusing on operations of the process cartridge 140y. The process cartridges 140y, 140c, 140m, and 140bk have identical structures with toners of different colors. The process cartridge 140y includes an image carrying member 102y and various image forming components including a charging roller 107y, a developing unit 109y, and a cleaning unit 113y. The developing unit 109y includes a developing roller lily, a developing blade 131y, and toner conveying screws 132y and 133y. The parts of the developing unit 109y are encased in a developing case 110y that contains a dry-type developer D. The cleaning unit 113y includes a cleaning blade 135y and a collected-toner conveying screw 136y. The parts of the cleaning unit 113y are encased in a cleaning case 134y. According to the image forming apparatus 100 of the present invention, the developing case 110y and the cleaning case 134y are integrally mounted to form a unit case 141y. The unit case 141y has a light passing window 144y at the bottom thereof.

The transfer medium 101b includes an intermediate transfer belt 103. The intermediate transfer belt 103 is supported by a plurality of supporting rollers 104, 105, and 106, and is held in contact with primary transfer rollers 112y, 112c, 112m, and 112bk which correspond to the image carrying members 102y, 102c, 102m, and 102bk, respectively.

The optical writing system 101c includes an optical writing device (not shown).

The sheet feeding mechanism 101d includes a sheet feeding cassette 114, a sheet feeding roller 115, a sheet feeding unit 116, a registration roller pair 117, a secondary transfer roller 118, a fusing unit 119, a sheet discharging roller pair 120, a sheet discharging part 122, and a belt cleaning unit 124.

The toner feeding mechanism 101e includes toner bottles 137y, 137c, 137m, and 137bk.

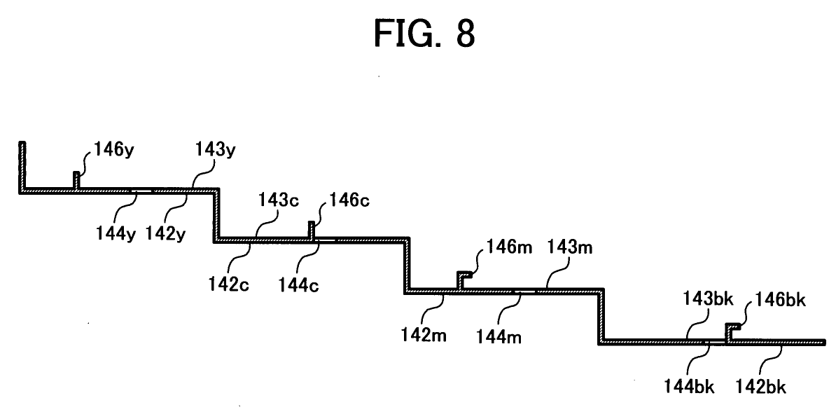

The guiding mechanism 101f includes a guide 142 having guide portions 142y, 142c, 142m, and 142bk which are explained with reference to FIG. 8. The guide portions 142y, 142c, 142m, and 142bk have supporting surfaces 143y, 143c, 143m, and 143bk, and guide protrusions 146y, 146c, 146m, and 146bk, respectively.

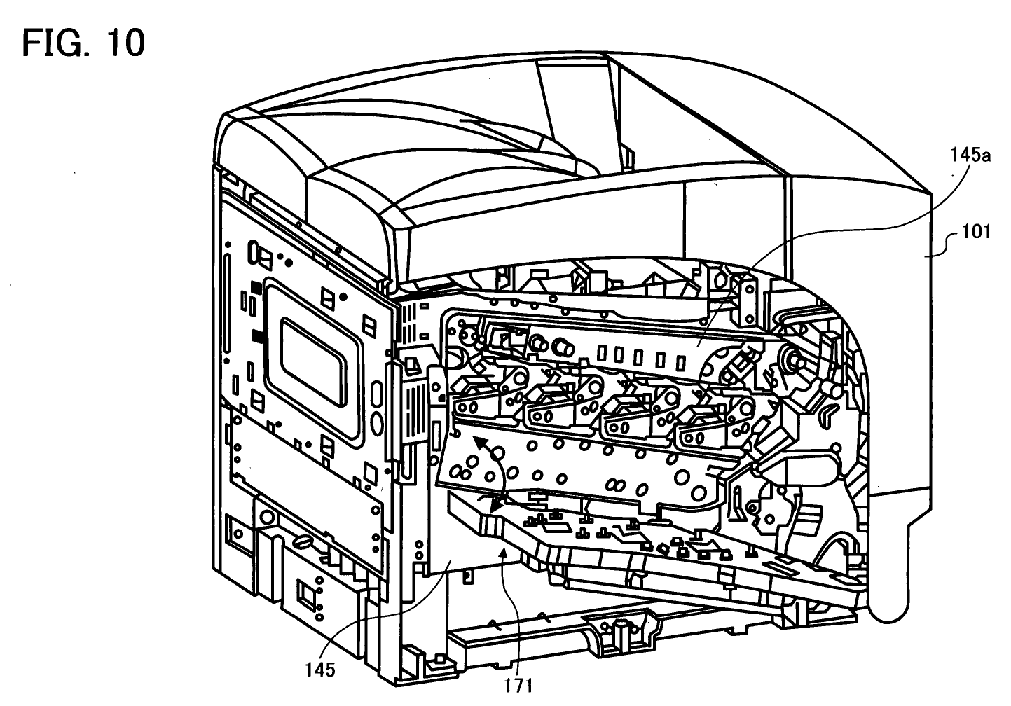

The image forming apparatus 100 of the present invention also includes an opening 145a (shown in FIG. 10) on a front side panel thereof.

The intermediate transfer belt 103 is arranged above the image forming mechanism 101a at a predetermined angle relative to the horizontal plane with one end of the intermediate transfer belt 103 close to the supporting roller 105 higher than the other end thereof. The predetermined angle is preferably in a range from approximately 10 degrees to approximately 20 degrees, and is preferably approximately 15 degrees.

The image forming apparatus 100 produces a full-color image through the following operations. The optical writing system 101c emits laser beams to the image forming mechanism 101a supported by the guiding mechanism 101f. The image forming mechanism 101a produces different color images with toners which are conveyed by the toner feeding mechanism 101e, and transfers the images one after another onto the transfer medium 101b to form a superimposed full-color image. The transfer medium 101b then transfers the superimposed fullcolor image onto a recording medium fed by the sheet feeding mechanism 101d. The full-color image transferred onto the recording medium 101b is fixed and then discharged onto the top of the image forming apparatus 100.

Referring to FIG. 7, operations of the image forming mechanism 101a are explained. As previously described, the process cartridges 140y, 140c, 140m, and 140bk have identical structures. Therefore, an explanation will be given focusing on the operations performed by the process cartridge 140y. The image carrying member 102y has a drum-shaped photoconductive element and forms an electrostatic latent image for a single color toner image on its surface. The image forming components are arranged around the image carrying member 102y and form the single color toner image based on the electrostatic latent image formed on the image carrying member 102y.

The image carrying member 102y rotates clockwise. The charging roller 107y is applied with a charged voltage and then charges the image carrying member 102y to a

predetermined polarity to form an electrostatic latent image on the image carrying member 102y. The optical writing system 101c emits and irradiates the image carrying member 102y with a laser beam L.

The developing unit 109y visualizes the electrostatic latent image as a yellow toner image. The developing roller lily is rotatably supported by the developing case 110y and is closely placed opposite to the image carrying member 102y through an open space formed on the developing case 110y.

The developing blade 131y regulates an amount of the dry-type developer D on the developing roller lily. The toner conveying screws 132y and 133y are oppositely provided to the developing roller lily. The dry-type developer D in the developing case 110y is agitated by the toner conveying screws 132y and 133y, carried onto the surface of the developing roller lily, and then conveyed by the developing roller lily rotating in a direction B, as indicated in FIG. 7. The developing blade 131y regulates the dry-type developer D accumulated on the surface of the developing roller 111y to a fixed level. The dry-type developer D of the regulated amount adhering on the developing roller lily is conveyed to a developing area formed between the developing roller lily and the image carrying member 102y. In the developing area, toner contained in the dry-type developer D is electrostatically transferred onto an electrostatic latent image formed on the surface of the image carrying member 102y such that the electrostatic latent image becomes visualized as a toner image. The dry-type developer D may be a one-or a two-component developer. The present invention preferably uses a two-component developer including toner and carriers.

As shown in FIG. 6, the intermediate transfer belt 103 that serves as the transfer medium 101b forms an endless belt extended with pressure among the plurality of supporting rollers 104, 105, and 106, and rotates in a direction A.

The intermediate transfer belt 103 is arranged with an angle to a horizontal plane in an obliquely downward direction from left (LEFT) to right (RIGHT) of the image forming apparatus 100 in FIG. 6. The intermediate transfer belt 103 is held in contact with the primary transfer roller 112y arranged at a position opposite to the image carrying member 102y such that the toner image formed on the surface of the image carrying member 102y is transferred onto the intermediate transfer belt 103 to superimpose different color toner images to obtain a recorded image. The primary transfer roller 112y receives a transfer voltage and primarily transfers a yellow toner image onto the surface of the intermediate transfer belt 103 by an action of the transfer voltage.

As shown in FIG. 7, after the yellow toner image is transferred onto the intermediate transfer belt 103, the cleaning unit 113y scrapes the surface of the image carrying member 102y to remove residual toner adhering to the surface of the image carrying member 102y.

The cleaning unit 113y is encased by the cleaning case 134y that has an opening relative to the image carrying member 102y. The cleaning blade 135y has a base edge fixedly supported by the cleaning case 134y and a leading edge pressed onto the surface of the image carrying member 102y to scrape the residual toner adhering to the surface of the image carrying member 102y. The collected-toner conveying screw 136y conveys removed toner to a toner collecting bottle (not shown).

A voltage generated by a current that includes a direct current alternating current superimposed to is applied to the charging roller 107y. The charging roller 107y then simultaneously discharges and charges the surface of the image carrying member 102y with the voltage applied thereto. Namely, the image carrying member 102y is prepared for the next image forming operation, i.e., a yellow toner image is formed thereon and transferred onto the intermediate transfer belt 103.

Through operations similar to those as described above, a cyan toner image, a magenta toner image, and a black toner image are formed on the surfaces of the image carrying members 102c, 102m, and 102bk, respectively. Those color toner images are sequentially superimposed on the surface of the intermediate transfer belt 103 on which the yellow toner image is already formed, such that a primary superimposed toner image is formed on the intermediate transfer belt 103. After the toner images in the different colors are transferred, residual toner on the image carrying members 102c, 102m, and 102bk is also removed by the cleaning units 113c, 113m, and 113bk, respectively. As shown in FIG. 6, the image forming components have the same numbers as those corresponding to and arranged around the image carrying member 102y, with respective characters “c”, “m” and “bk” according to their respective colors.

As shown in FIG. 6, the sheet feeding mechanism 101d is arranged at the lower part of the image forming apparatus 100.

The sheet feeding cassette 114 accommodates a plurality of recording media such as transfer sheets that include a recording medium P. The sheet feeding roller 115 provided at the top of the sheet feeding unit: 116 feeds recording media. When the sheet feeding roller 115 is rotated, the recording medium P, placed on the top of a sheet stack of recording media in the sheet feeding cassette 114, is fed in a direction C as indicated in FIG. 6. The recording medium P, fed from the sheet feeding cassette 114, is conveyed to the registration roller pair 117. The registration roller pair 117 stops and feeds the recording medium P in synchronization with a movement of the superimposed toner image towards a transfer area formed between the intermediate transfer belt 103 and the secondary transfer roller 118. The secondary transfer roller 118 is applied with an adequate predetermined transfer voltage such that a primary superimposed toner image, formed on the surface of the intermediate transfer belt 103, is transferred onto the recording medium P to form a secondary superimposed toner image.

The recording medium P that has the secondary superimposed toner image thereon is conveyed further upward and passes between a pair of fusing rollers of the fusing unit 119. The fusing unit 119 fixes the secondary superimposed toner image to the recording medium P by applying heat and pressure. After the recording medium P passes the fusing unit 119, the recording medium P is discharged face-down by the sheet discharging roller pair 120 to the sheet discharging part 122 provided at the upper portion of the image forming apparatus 100. The belt cleaning unit 124 scrapes the surface of the intermediate belt 103 and removes residual toner adhering onto the surface of the intermediate transfer belt 103.

As shown in FIG. 6, the toner bottles 137y, 137c, 137m, and 137bk of the toner feeding mechanism 101e are provided at the upper portion of the image forming apparatus 100 and contain yellow, cyan, magenta, and black toners, respectively. Yellow, cyan, magenta, and black toners are conveyed from the toner bottles 137y, 137c, 137m, and 137bk, respectively, through respective conveying paths (not shown) to supply the developing units 109y, 109c, 109m, and 109bk, respectively.

As previously described, a process cartridge (140y, 140c, 140m, and 140bk) is formed by an image carrying member (102y, 102c, 102m, and 102bk) and at least a part of the image forming mechanism 101a. The image carrying member (102y, 102c, 102m, and 102bk) has a surface on which an electrostatic latent image for a corresponding color out of predetermined colors is formed. The image forming mechanism 101a is integrally mounted with the image carrying member (102y, 102c, 102m, and 102bk). The image forming mechanism 101a is configured to form a toner image in a corresponding color based on the electrostatic latent image formed on the image carrying member (102y, 102c, 102m, and 102bk). The image forming apparatus 100 includes a plurality of process cartridges (140y, 140c, 140m, and 140bk) configured to transfer yellow, cyan, magenta, and black toner images, respectively, formed on the image carrying members 102y, 102c, 102m, and 102bk, respectively, into a full-color toner image onto the intermediate transfer belt 103. More specifically, in the process cartridge 140y, the developing case 110y, and the cleaning case 134y are integrally formed as a unit case 141y, as shown in FIG. 7. The image carrying member 102y is rotatably supported by the unit case 141y. The image carrying member 102y, developing unit 109y, cleaning unit 113y, and charging roller 107y are integrally mounted to form process cartridge 140y. As previously described, the process cartridge does not necessarily include an entire portion of the image forming mechanism. The process cartridge may include the image carrying member and at least one of the charging unit, the developing unit and the cleaning unit.

The image carrying members 102y, 102c, 102m, and 102bk are in contact with a bottom surface of the intermediate transfer belt 103 between the supporting rollers 105 and 106, and are arranged such that the supporting roller 105 is disposed higher than the supporting roller 106. As shown in FIG. 6, the process cartridges 140y, 140c, 140m, and 140bk may be removed in an axial direction of the image carrying members 102y, 102c, 102m, and 102bk, respectively.

FIG. 8 illustrates a sectional view of the guide 142 including the guide portions 142y, 142c, 142m, and 142bk arranged in a stepped manner, according to an embodiment of the present invention. The guide 142 includes the guide portions 142y, 142c, 142m, and 142bk, and is fixed to the image forming apparatus 100. The supporting surfaces 143y, 143c, 143m, and 143bk are mounted substantially horizontally and have respective bottom and side surfaces for supporting the process cartridges 140y, 140c, 140m, and 140bk. The supporting surfaces 143y, 143c, 143m, and 143bk guide the process cartridges 140y, 140c, 140m, and 140bk when the process cartridges 140y, 140c, 140m, and 140bk are inserted into or removed from the image forming apparatus 100. The supporting surfaces 143y, 143c, 143m, and 143bk are arranged at positions having different heights in a stepped manner according to positional heights of the process cartridges 140y, 140c, 140m, and 140bk. The guide portions 142y, 142c, 142m, and 142bk of the guide 142 support the process cartridges 140y, 140c, 140m, and 140bk, and have a predetermined angle to the horizontal plane and are arranged parallel to the intermediate transfer belt 103. The guide portions 142y, 142c, 142m, and 142bk and the unit cases 141y, 141c, 141m, and 141bk of the process cartridges 140y, 140c, 140m, and 140bk include the light passing windows 144y, 144c, 144m, and 144bk, respectively, for passing a laser beam L emitted by the optical writing system 101c to the image carrying members 102y, 102c, 102m, and 102bk, respectively. Further, as shown in FIG. 7, the developing case 110y includes a protrusion 149y in the vicinity of the toner conveying screw 133y such that the process cartridge 140y is guided along a vertical side of the guide portion 142y. The other developing cases 110c, 110m, and 110bk are arranged in a similar manner. Accordingly, the vertical side of the guide portion 142y is also used as a guide member for the process cartridge 140y.

The image forming apparatus 100 includes an internal front panel 145 (see FIG. 10) disposed over an internal front side of the image forming apparatus 100 (the surface side of the figure). The internal front side panel 145 covers the internal portions of the image forming apparatus 100 including the process cartridges 140y, 140c, 140m, and 140bk, the intermediate transfer belt 103, and the optical writing system 101c. The internal front panel. 145 has an opening 145a formed as indicated by the chain double-dashed lines shown in FIG. 6. The process cartridges 140y, 140c, 140m, and 140bk are removable through the opening 145a. Further, the image forming apparatus 100 includes a cover plate 171 which is hingedly mounted to the internal front panel 145 to cover the opening 145a. The cover plate 171 may be opened and closed, and has a shape for determining with precision the positions of the process cartridges 140y, 140c, 140m, and 140bk. For instance, holes may be used for determining with precision the positions of the process cartridges 140y, 140c, 140m, and 140bk. When the cover plate 171 is set to a closed position, an engaging mechanism (not shown) completely fixes positions of the image carrying members of the process cartridges to perform the image forming operation. FIG. 10 illustrates a perspective view of the image forming apparatus 100 and shows a relationship between the opening 145a and the cover plate 171.

According to this configuration, when the process cartridge 140y is checked, repaired, or replaced, a user may pull the process cartridge 140y in a direction towards the user to detach it from the supporting surface 143y. The user may place and push the process cartridge 140y on the supporting surface 143y in a reverse direction to attach it. Namely, the user may remove and insert the process cartridge while keeping it horizontal. Therefore, there is no need to engage the slide rail provided on the process cartridge with the guide rail provided on the image forming apparatus. Further, by opening the cover plate 171 of the image forming apparatus 100, the user may instantly recognize the position of the supporting surface 143y and understand that the supporting surface 143y may be used to guide the process cartridge 140y when the process cartridge 140y is inserted or removed. Thus, even an inexperienced user may easily attach and detach the process cartridge 140y while keeping it horizontal. This process may also be applied to the other process cartridges 140c, 140m, and 140bk.

Further, the image forming apparatus 100 includes a regulating member configured to regulate a path of the process cartridge. The regulating member prevents the process cartridge from undesirable movements in a direction perpendicular to the path of the process cartridge along the plane of the supporting surface of the guide during attachment and detachment. Thus, the process cartridge does not cause interference and damage to another process cartridge placed next to it. As shown in FIG. 7, the guide portion 142y includes the regulating member that has a guide protrusion 146y protruding upward from the supporting surface 143y of the guide portion 142y and extending toward a removing direction of the process cartridge 140y. The guide protrusion 146y may be slidably engaged in a groove 148y formed on the unit case 141y of the process cartridge 140y to prevent the process cartridge 140y from undesirable movements in a direction perpendicular to the path of the process cartridge 140y during attachment and detachment. Alternatively, the process cartridge 140y may include the guide protrusion 146y and the supporting surface 143y may include the groove 148y. The processes described above relating to the yellow toner as indicated by the character “y” may also be applied to parts and units related to the cyan, magenta, and black toners as indicated by the characters “c”, “m” and “bk”.

In FIG. 8, the guide portions 142y, 142c, 142m, and 142bk may include the guiding protrusions 146y, 146c, 146m, and 146bk, and may have different shapes and mounting locations to properly engage respective grooves included in the process cartridges 140y, 140c, 140m, and 140bk.

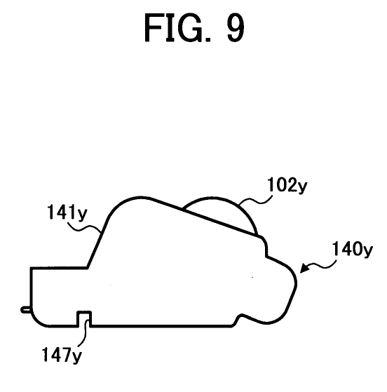

FIG. 9 illustrates the unit case 141y of the process cartridge 140y that has a guide groove 147y thereon. The unit case 141y of the process cartridge 140y includes the guide groove 147y which may be engaged with the guide protrusion 146y included in the guide portion 144y close to the vertical side of the guide portion 144y, as shown in FIG. 8. Improper insertion of the process cartridges may be prevented by varying the form or the locations of the guide protrusions and the guide grooves. Alternatively, the guide portions 142y, 142c, 142m, and 142bk may include the guide grooves 147y, 147c, 147m, and 147bk and the process cartridges 140y, 140c, 140m, and 140bk may include the guide protrusions 146y, 146c, 146m, and 146bk such that the process cartridges 140y, 140c, 140m, and 140bk are prevented from being misaligned. Thus, an improper insertion of process cartridge may also be prevented. An erroneous supply of improper color toner to a developing unit may also be prevented. As a result, the quality deterioration of the image due to color toner mixture is avoided.

Further, the image forming apparatus 100 includes an elevating member (not shown) which allows the guide portions 142y, 142c, 142m, and 142bk to move vertically. When detaching the process cartridges 140y, 140c, 140m, and 140bk, the elevating member descends the guide portions 142y, 142c, 142m, and 142bk supporting the process cartridges 140y, 140c, 140m, and 140bk such that the image carrying members 102y, 102c, 102m, and 102bk separate from the intermediate transfer belt 103. The separation avoids rubbing and damaging the surfaces of the image carrying members 102y, 102c, 102m, and 102bk, and the surface of the intermediate transfer belt 103. The guide portions 142y, 142c, 142m, and 142bk may be configured to elevate collectively or individually. If the guide portions 142y, 142c, 142m, and 142bk are individually movable, a user can selectively descend the guide portions 142y, 142c, 142m, and 142bk to attach or detach a desired process cartridge.

Alternatively, the intermediate transfer belt 103 may be eliminated with the images directly transferred onto a recording paper sheet.

As shown in FIG. 6, the image forming apparatus 100 includes toner bottles 137y, 137c, 137m, and 137bk which are separately mounted to the process cartridges 140y, 140c, 140m, and 140bk, respectively. The toner bottles 137y, 137c, 137m, and 137bk of different colors are provided above the intermediate transfer belt 103 and correspond to the process cartridges 140y, 140c, 140m, and 140bk, respectively, such that each color toner is conveyed to a corresponding one of the process cartridges 140y, 140c, 140m, and 140bk. The toner bottles 137y, 137c, 137m, and 137bk may be replaced separately from the process cartridges 140y, 140c, 140m, and 140bk when a toner needs to be replenished. Also, the process cartridges 140y, 140c, 140m, and 140bk may be replaced separately from the toner bottles 137y, 137c, 137m, and 137bk when a component needs to be replaced. Thus, this structure allows separate exchanges of toner and process cartridges, thereby reducing the maintenance cost for the user. Therefore, the number of opening and closing operations of the cover plate 171 may be reduced and the number of replacements of the process cartridges may also be reduced. Thereby, toner scattering in an area such as a shutter area may be prevented and operator maintainability is improved.

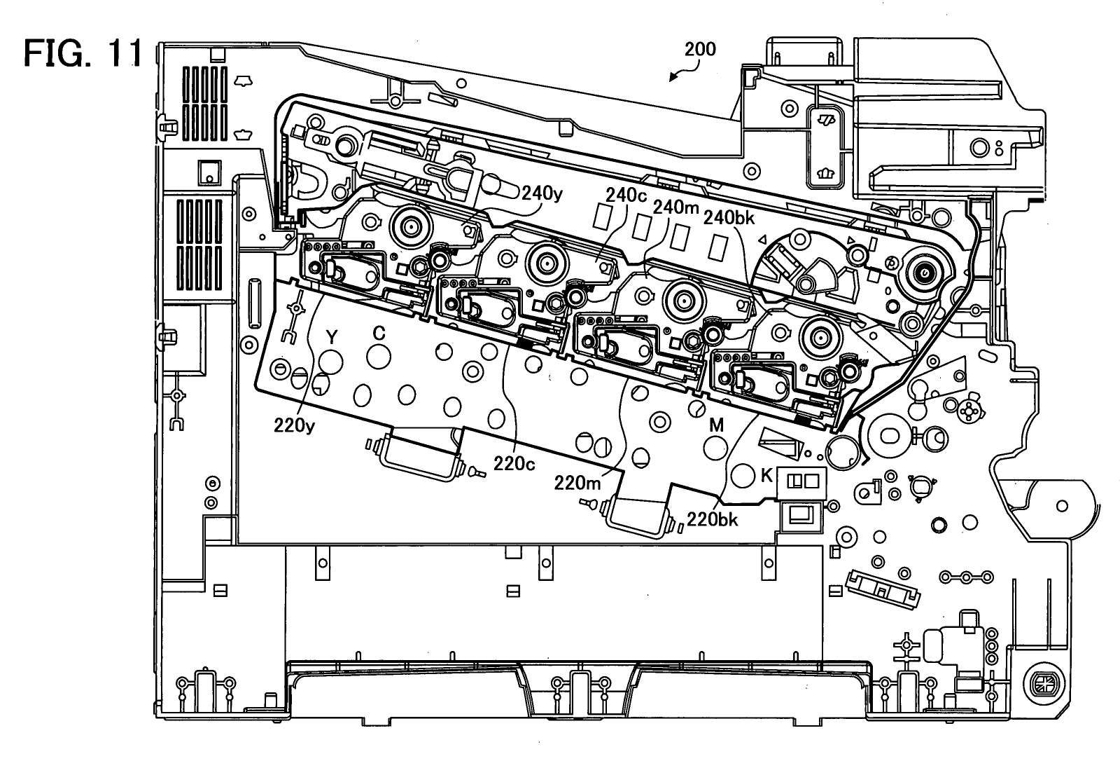

Next, an image forming apparatus 200 according to another embodiment of the present invention will be described with reference to FIGS. 6 through 12. FIG. 11 shows an image forming apparatus 200 that includes guide portions 220y, 220c, 220m, and 220bk and process cartridges 240y, 240c, 240m, and 240bk. The image forming apparatus 200 is similar to the image forming apparatus 100 of FIG. 6.

In the discussion following, suffix characters “y”, “c”, “m” and “bk” are attached to reference numbers of components and represent respective colors. Based on this suffix system, the following explanation primarily focuses on the yellow color mechanism section.

The remaining color mechanism sections have similar structures.

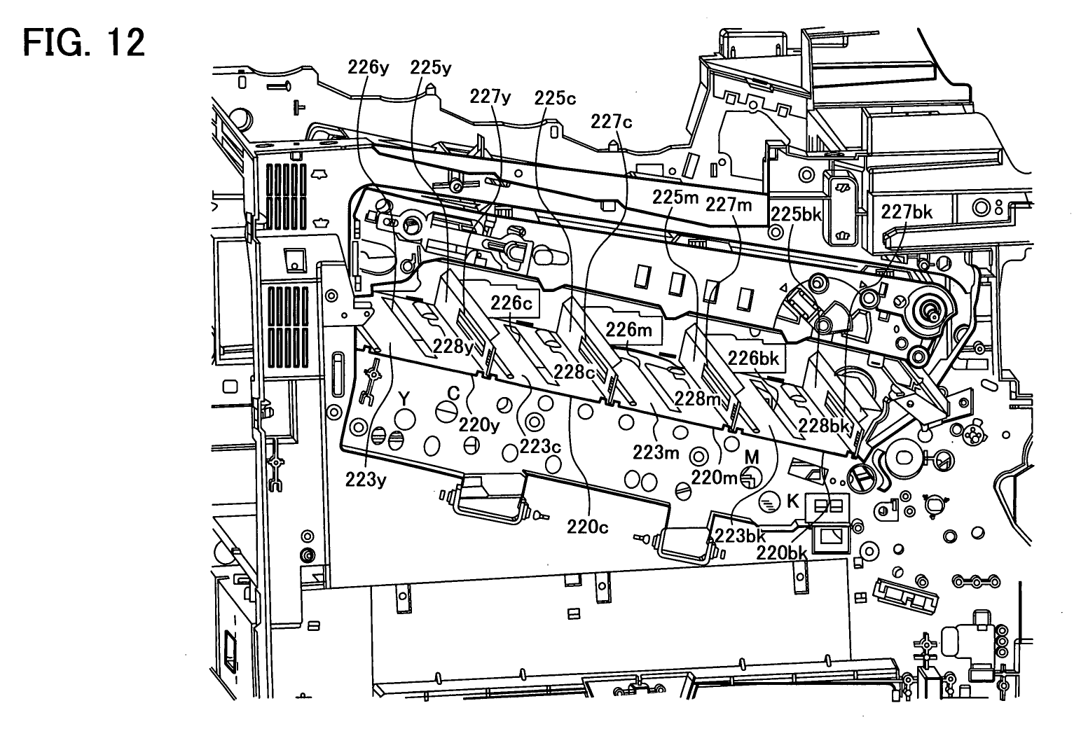

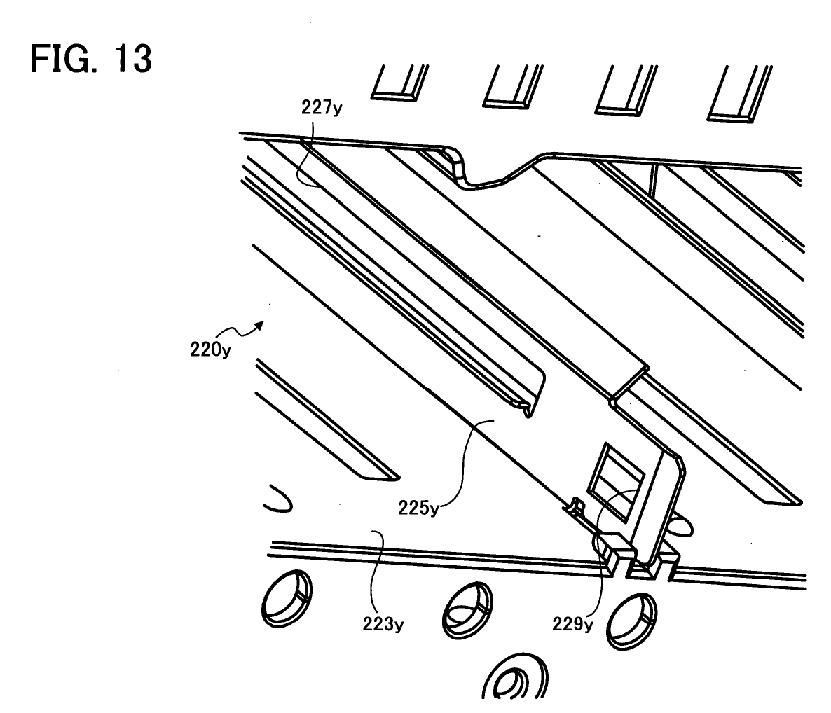

As shown in FIG. 12, the guide portions 220y, 220c, 220m, and 220bk of the image forming apparatus 200 include supporting surfaces 223y, 223c, 223m, and 223bk, and regulating members 225y, 225c, 225m, and 225bk. The supporting surfaces 223y, 223c, 223m, and 223bk include light passing windows 226y, 226c, 226m, and 226bk, and pushup members 228y, 228c, 228m, and 228bk. The regulating members 225y, 225c, 225m, and 225bk include guide openings 227y, 227c, 227m, and 227bk. FIG. 13 illustrates a positioning hole 229y of the regulating member 225y.

Further, while each of the supporting surfaces 143y, 143c, 143m, and 143bk of corresponding guide portions 142y, 142c, 142m, and 142bk is arranged approximately horizontally in the image forming apparatus 100, each of the supporting surfaces 223y, 223c, 223m, and 223bk of corresponding guide portions 220y, 220c, 220m, and 220bk is arranged to be inclined relative to a horizontal plane in the image forming apparatus 200.

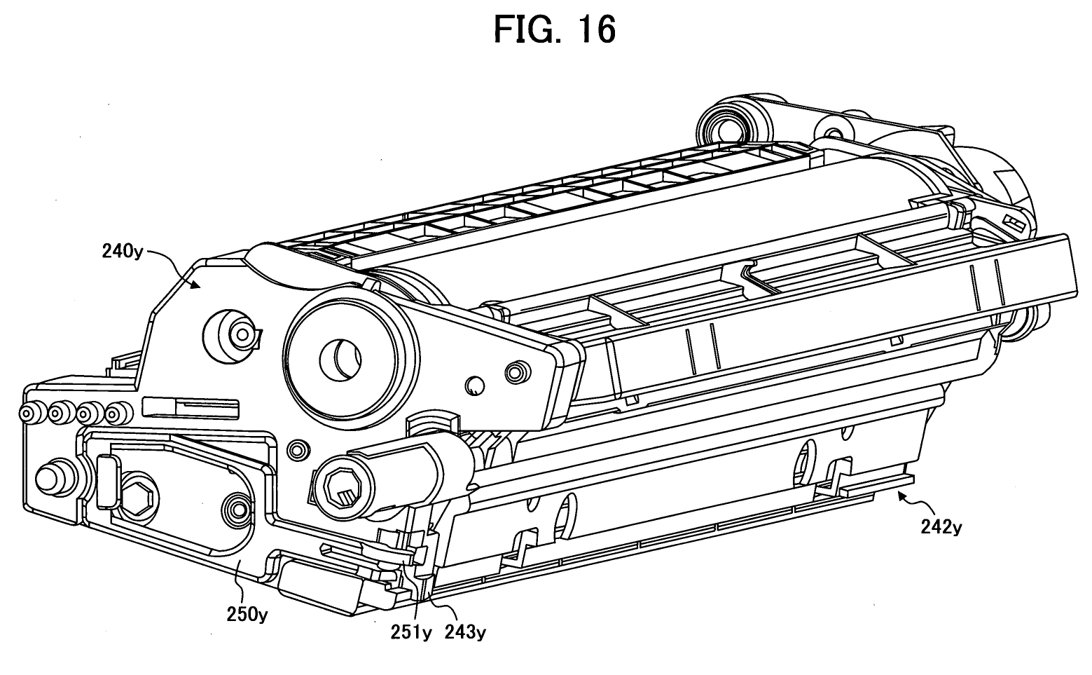

The process cartridges 240y, 240c, 240m, and 240bk of the image forming apparatus 200, shown in FIG. 11, are similar to the process cartridges 140y, 140c, 140m, and 140bk, respectively, of the image forming apparatus 100, shown in FIG. 6, with the exception of the guide portion 220y, for example, a convex portion 242y, a positioning latch 243y, a lever 250y, and a cam 251y, as shown in FIG. 16.

This structure allows a sliding movement of each of the process cartridges 240y, 240c, 240m, and 240bk in a stable manner. More specifically, the process cartridge 240y slidably moves on the guide portion 220y while pressing down both the supporting surface 223y and the regulating member 225y by its own weight, thereby avoiding undesirable movements of the process cartridge 240y in a direction parallel to the supporting surface 223y.

Detailed structures of the guide portions 220y, 220c, 220m, and 220bk and the process cartridges 240y, 240c, 240m, and 240bk different from those of the guide portions 142y, 142c, 142m, and 142bk, and the process cartridges 140y, 140c, 140m, and 140bk will now be described.

FIG. 12 shows the inside of the image forming apparatus 200 when the process cartridges 240y, 240c, 240m, and 240bk are removed. Each of the guide portions 220y, 220c, 220m, and 220bk has an L-shaped form. The supporting surfaces 223y, 223c, 223m, and 223bk support the bottom surfaces of the process cartridges 240y, 140c, 240m, and 240bk, respectively. The light passing windows 226y, 226c, 226m, and 226bk are included in the supporting surfaces 223y, 223c, 223m and 223bk, respectively. Each of the light passing windows 226y,, 226c, 226m, and 226bk passes a laser beam emitted by an optical writing system which is positioned under the guide portions 220y, 220c, 220m, and 220bk. The supporting surfaces 223y, 223c, 223m, and 223bk include pushup members 228y, 228c, 228m, and 228bk, respectively. The pushup members 228y, 228c, 228m, and 228bk guide the process cartridges 240y, 240c, 240m, and 240bk, respectively, such that the process cartridges 240y, 240c, 240m, and 240bk are pushed up to positions contacting the intermediate transfer belt. The regulating members 225y, 225c, 225m, and 225bk are arranged approximately perpendicular to the supporting surfaces 223y, 223c, 223m, and 223bk, respectively. The regulating members 225y, 225c, 225m, and 225bk regulate movement of the process cartridges 240y, 240c, 240m, and 240bk, respectively, to precise positions. The regulating members 225y, 225c, 225m, and 225bk include guide openings 227y, 227c, 227m, and 227bk and positioning holes 229y, 229c, 229m, and 229bk, respectively. Each of the guide openings 227y, 227c, 227m, and 227bk guides a corresponding one of the process cartridges 240y, 240c, 240m, and 240bk. Each of the positioning holes 229y, 229c, 229m, and 229bk is positioned at one edge side of the regulating member close to the cover plate 171, and determines a preliminary operable position of a corresponding one of the process cartridges 240y, 240c, 240m, and 240bk, respectively.

Referring to FIGS. 8 through 12, the guide portion 220y and the process cartridge 240y are primarily shown. The guide portions 220y, 220c, 220m, and 220bk have identical structures. The process cartridges 240y, 240c, 240m, and 240bk also have identical structures with toners different in colors from each other.

FIG. 13 shows an enlarged view of the guide portion 220y. When the process cartridge 240y is slid on the angled supporting surface 223y, the process cartridge 240y presses by its own weight the supporting surface 223y such that undesirable movements in a direction different from the sliding direction are eliminated. The convex portion 242y, shown in FIG. 16, is included at a leading portion of the process cartridge 240y and is configured to be engaged with the guide opening 227y formed on the regulating member 225y of the guide portion 220y. This regulates movements of the process cartridge 240y towards the intermediate transfer belt such that the process cartridge 240y may maintain a distance from the intermediate transfer belt. This prevents damage to a photoconductive drum of the process cartridge 240y and the intermediate transfer belt. When the process cartridge 240y is inserted into the image forming apparatus 200 a certain distance corresponding to a predetermined length of the guide portion 220y, the convex portion 242y of the process cartridge 240y moves off the guide opening 227y. Then, as the process cartridge 240y is inserted, the process cartridge 240y is lifted in a vertical direction by and onto the pushup member 228y of the supporting surface 223y. As a result, the photoconductive drum of the process cartridge 240y contacts the intermediate transfer belt.

To avoid damage to the intermediate transfer belt, the process cartridge 240y is preferably separated from the intermediate transfer belt when the process cartridge 240y is installed. However, the process cartridge 240y needs to be set to a predetermined preliminary position and held in contact with the intermediate transfer belt to perform the image forming operation. As previously described, when the process cartridge 240y is inserted into the image forming apparatus 200, it is guided by the guide opening 227y of the regulating member 225y and the pushup member 228y of the supporting surface 223y. At the preliminary position, the positioning latch 243y of the process cartridge 240y is kept into the positioning hole 229y of the guide portion 220y such that the positioning latch 243y and the positioning hole 229y are engaged to determine the preliminary position of the process cartridge 240y. The process cartridge 240y located at the preliminary position is fixed to a precise position by closing the cover plate 171.

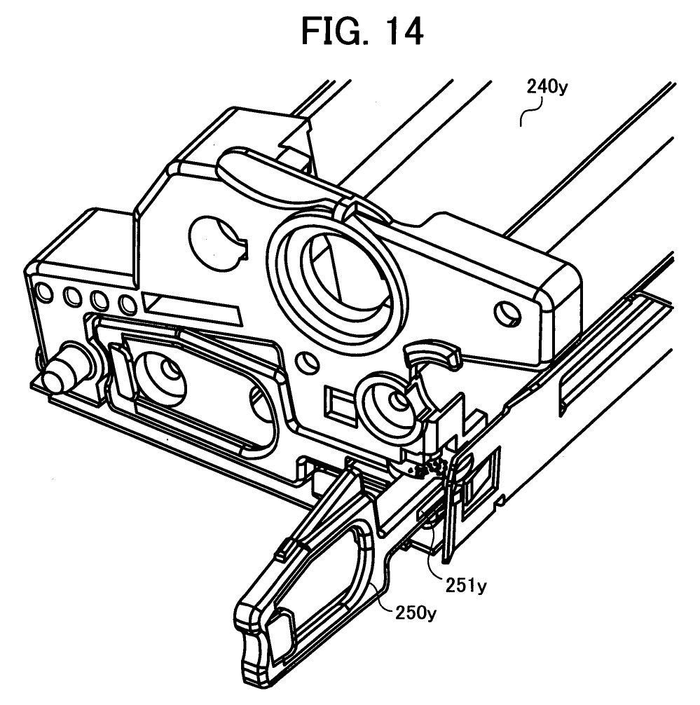

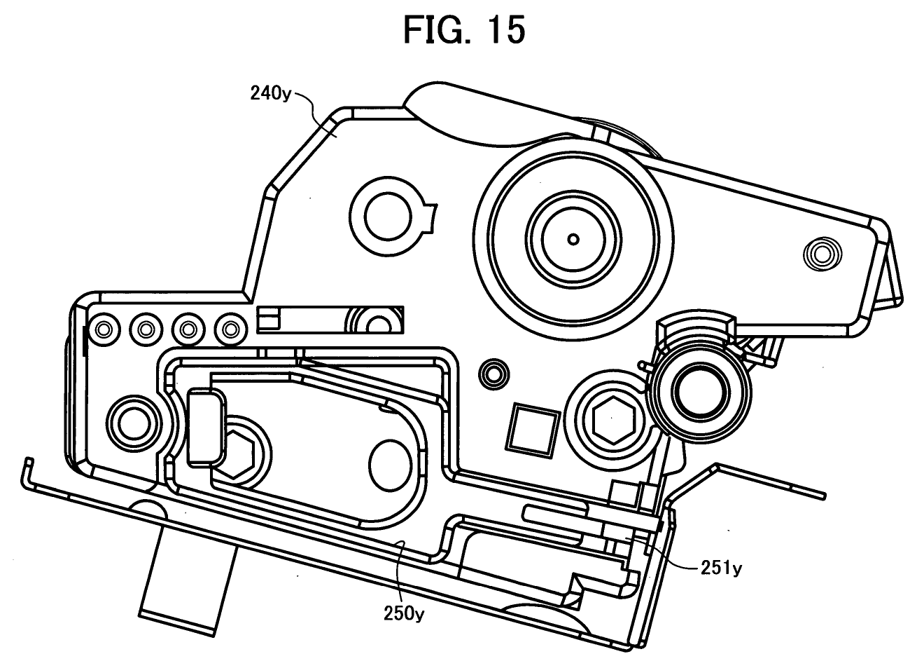

FIGS. 11, 12, and 14-17 show installation and removal of the process cartridge 240y. In this embodiment of the present invention, the image forming apparatus 200 has the positioning hole 229y and the positioning latch 243y. When the process cartridge 240y is inserted, the positioning latch 243y of the process cartridge 240y fits in the positioning hole 229y of the guide portion 220y by the weight of the process cartridge 240y. Thus, the process cartridge 240y is set to the preliminary position and a locking pressure is applied such that the process cartridge 240y is locked. The process cartridge 240y is then fixed to the precision position by the cover plate 171 as previously described. To 5 release the process cartridge 240y from its precise position, the lever 250y of the process cartridge 240y is used.

As previously described, the process cartridge 240y has the lever 250y which is arranged at a position close to the 10 positioning latch 243y. The lever 250y is pulled out, and the cam 251y provided at a hinge portion of the lever 250y contacts the regulating member 225y of the guide portion 220y and pushes up the process cartridge 240y. The positioning latch 243y of the process cartridge 240y is disengaged from 15 the positioning hole 229y of the guide portion 220y. The process cartridge 240y is then easily removed by pulling the lever 250y.

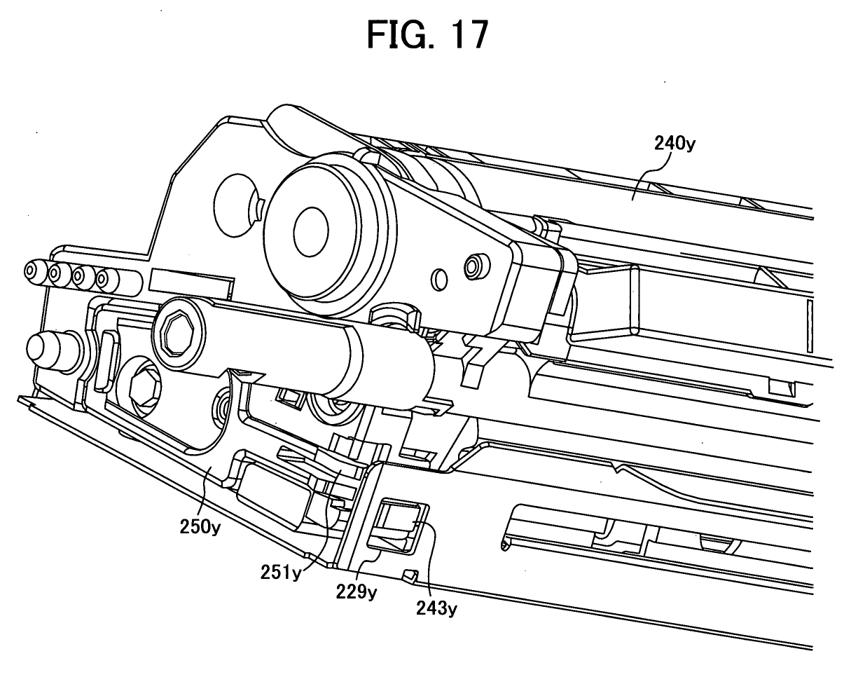

FIG. 16 is a perspective view of the process cartridge 240y and FIG. 17 is an enlarged view of a part of the process 20 cartridge 240y. A bottom side of the process cartridge 240y is formed approximately flat so that the process cartridge 240y is smoothly inserted along the guide portion 220y. The convex portion 242y of the process cartridge 240y is arranged at a lower part of the process cartridge 240y to face the 25 regulating member 225y and to be close to the pushup member 228y when the process cartridge 240y is in an operational position.

A process cartridge having a structure of the present invention may easily and smoothly be installed and removed along a guide member eliminating undesirable movements by its own weight.

Similar to the image forming apparatus 100, the image forming apparatus 200 of the present invention includes toner bottles (not shown in FIG. 11) which are separately mounted to the process cartridges 240y, 240c, 240m, and 240bk. Namely, the toner bottles may be replaced separately from the process cartridges 240y, 240c, 240m, and 240bk when toner needs to be replenished. Also, the process cartridges 240y, 240c, 240m, and 240bk may be replaced separately from the toner bottles when a component needs to be replaced.

Numerous additional modifications and variations are possible in light of the above teachings. It is therefore to be understood that within the scope of the appended claims, the disclosure of this patent specification may be practiced otherwise than as specifically described herein.

What is claimed is:

1. A process cartridge detachably mounted to an image forming apparatus, said cartridge comprising:
a photoconductive element; and
a housing configured to house said photoconductive element, said housing comprising a guide portion configured to guide the process cartridge.

2. The process cartridge according to claim 1, wherein said guide portion faces one of an inner wall of the image forming apparatus and another process cartridge adjoining said process cartridge.

3. The process cartridge according to claim 1, wherein guide portion is configured to guide said another process cartridge adjoining said process cartridge.

4. The process cartridge according to claim 1, wherein said guide portion is configured to slidably engage with a portion of another process cartridge adjoining said process cartridge.

5. The process cartridge according to claim 1, wherein said guide portion varies in shape in accordance with a location of said guide portion in the image forming apparatus.

6. The process cartridge according to claim 1, wherein a configuration of said guide portion is one of being separately formed from said housing and being integrated with said housing.

7. An image forming apparatus, comprising: an image transfer mechanism; and
a process cartridge detachably mounted, the process cartridge comprising:
a photoconductive element; and
a housing configured to house said photoconductive element, said housing comprising a guide portion configured to guide the process cartridge.

8. An image forming apparatus, comprising: an image transfer mechanism; and
a plurality of process cartridges detachably mounted to said image forming apparatus, each one of the plurality of process cartridges being arranged parallel to the others and forming an image for a single color, each of the process cartridges comprising:
a photoconductive element; and
a housing configured to house said photoconductive element, said housing comprising a guide portion configured to guide the process cartridge.

9. A process cartridge detachably mounted to an image forming apparatus, said cartridge comprising:
image carrying means for carrying an image; and
housing means for housing said image carrying means, said housing means further comprising guiding means for guiding the process cartridge.

10. The process cartridge according to claim 9, wherein said guiding means faces one of an inner wall of the image forming apparatus and another process cartridge adjoining said process cartridge.

11. The process cartridge according to claim 9, wherein said guiding means guides another process cartridge adjoining said process cartridge.

12. The process cartridge according to claim 9, wherein said guiding means slidably engages with a portion of process cartridge adjoining said process cartridge.

13. The process cartridge according to claim 9, wherein said guiding means varies in shape in accordance with a location of said guiding means in the image forming apparatus.

14. The process cartridge according to claim 9, wherein a configuration of said guiding means is one of being separately formed from said housing means and being integrated with said housing means.

15. An image forming apparatus, comprising:
an image forming means; and
a process cartridge detachably mounted therein, the process cartridge comprising:
image carrying means for developing an image; and
housing means for housing said image carrying means, said housing means further comprising guiding means for guiding the process cartridge.

16. An image forming apparatus, comprising:
an image forming means; and
a plurality of process cartridges, each process cartridge of said plurality being detachably mounted to said image forming apparatus, being arranged in parallel to the other cartridges, and being configured to form an image for a single color, each of the process cartridges comprising:
image carrying means for developing an image; and
housing means for housing said image carrying means, said housing means further comprising guiding means for guiding the process cartridge.

17. A method of providing a process cartridge detachably mounted in an image forming apparatus, the method comprising:
providing a photoconductive element; and
storing said photoconductive element in a housing comprising a guide portion configured to guide the process cartridge.

18. The method according to claim 17, wherein said storing further comprises arranging said guide portion to face one of an inner wall of the image forming apparatus and another process cartridge adjoining said process cartridge.

19. The method according to claim 17, wherein said guide portion is configured to guide another process cartridge adjoining said process cartridge.

20. The method according to claim 17, wherein said guide portion is configured to slidably engage with a portion of another process cartridge adjoining said process cartridge.

21. The method according to claim 17, wherein said guide portion varies in shape in accordance with a location of said guide portion in the image forming apparatus.

22. The method according to claim 17, wherein a configuration of said guide portion is one of being separately formed from said housing and being integrated with said housing.

23. A method of making an image forming apparatus, the method comprising:
providing an image transfer mechanism; and
providing a process cartridge detachably mounted in said image forming apparatus, the process cartridge comprising:
a photoconductive element; and
a housing configured to store said photoconductive element said housing further comprising a guide portion configured to guide the process cartridge.

24. A method of making an image forming apparatus, the method comprising:
providing an image transfer mechanism; and
providing a plurality of process cartridges, each process cartridge of said plurality being detachably mounted to said image forming apparatus, being arranged in parallel to the other cartridges, and being configured to form an image for a single color, each one of the process cartridges comprising:
a photoconductive element; and
a housing configured to store said photoconductive element, said housing further comprising a guide portion configured to guide the process cartridge.
